(19) United States
(12) Patent Application Publication
(10) Pub. No.: US 2025/0036721 A1
(43) Pub. Date: Jan. 30, 2025

(54) DETECTING ANOMALIES IN DEVICE TELEMETRY DATA USING DISTRIBUTIONAL DISTANCE DETERMINATIONS

(71) Applicant: Dell Products L.P., Round Rock, TX (US)

(72) Inventor: Philip E. Hummel, San Jose, CA (US)

(21) Appl. No.: 18/227,446

(22) Filed: Jul. 28, 2023

(51) Int. Cl. G06F 18/2413; G06N 20/00

(52) U.S. Cl. CPC G06F 18/24147; G06N 20/00

(57) ABSTRACT

Methods, apparatus, and processor-readable storage media for detecting anomalies in device telemetry data using distributional distance determinations are provided herein. An example computer-implemented method includes generating at least one reference data distribution for at least one telemetry data-related metric by processing historical telemetry data derived from devices using artificial intelligence techniques; generating, for at least one device, at least one data distribution for the at least one telemetry data-related metric by processing telemetry data derived from the at least one device using the artificial intelligence techniques; determining one or more distributional distance values by comparing at least a portion of the at least one data distribution to at least a portion of the at least one reference data distribution; identifying one or more anomalies based on the one or more distributional distance values; and performing automated actions based on the one or more identified anomalies.

### BACKGROUND

Significant volumes of telemetry data are produced for an increasing number of devices across numerous contexts and use cases. Much of that data, however, is discarded because conventional data processing approaches typically lack the ability to store such large amounts of data in a sufficient manner to enable meaningful analysis and/or information extraction. In connection with such conventional approaches, the costs and resource requirements for storing such large volumes of telemetry data commonly pose significant challenges, resulting in limited analysis of merely portions of telemetry data, which leads to accuracy issues and error-prone conclusions with respect to associated devices.

### SUMMARY

Illustrative embodiments of the disclosure provide techniques for detecting anomalies in device telemetry data using distributional distance determinations.

An exemplary computer-implemented method includes generating at least one reference data distribution for at least one telemetry data-related metric by processing historical telemetry data derived from one or more devices using one or more artificial intelligence techniques, and generating, for at least one device associated with one or more monitoring tasks, at least one data distribution for the at least one telemetry data-related metric by processing telemetry data derived from the at least one device using the one or more artificial intelligence techniques. The method also includes determining one or more distributional distance values associated with the at least one device with respect to the one or more devices by comparing at least a portion of the at least one data distribution to at least a portion of the at least one reference data distribution. Additionally, the method includes identifying one or more anomalies associated with at least a portion of the telemetry data derived from the at least one device based at least in part on the one or more distributional distance values, and performing one or more automated actions based at least in part on the one or more identified anomalies.

Illustrative embodiments can provide significant advantages relative to conventional data processing approaches. For example, problems associated with error-prone limited data analysis are overcome in one or more embodiments through detecting anomalies in device telemetry data using distributional distance determinations.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for detecting anomalies in device telemetry data using distributional distance determinations in an illustrative embodiment.

FIG. 2 shows an example reference distribution in an illustrative embodiment.

FIG. 3 shows an example graph of binning of continuous data in an illustrative embodiment.

FIG. 4 shows an example workflow for computing distributional distance values in an illustrative embodiment.

FIG. 5 is a flow diagram of a process for detecting anomalies in device telemetry data using distributional distance determinations in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

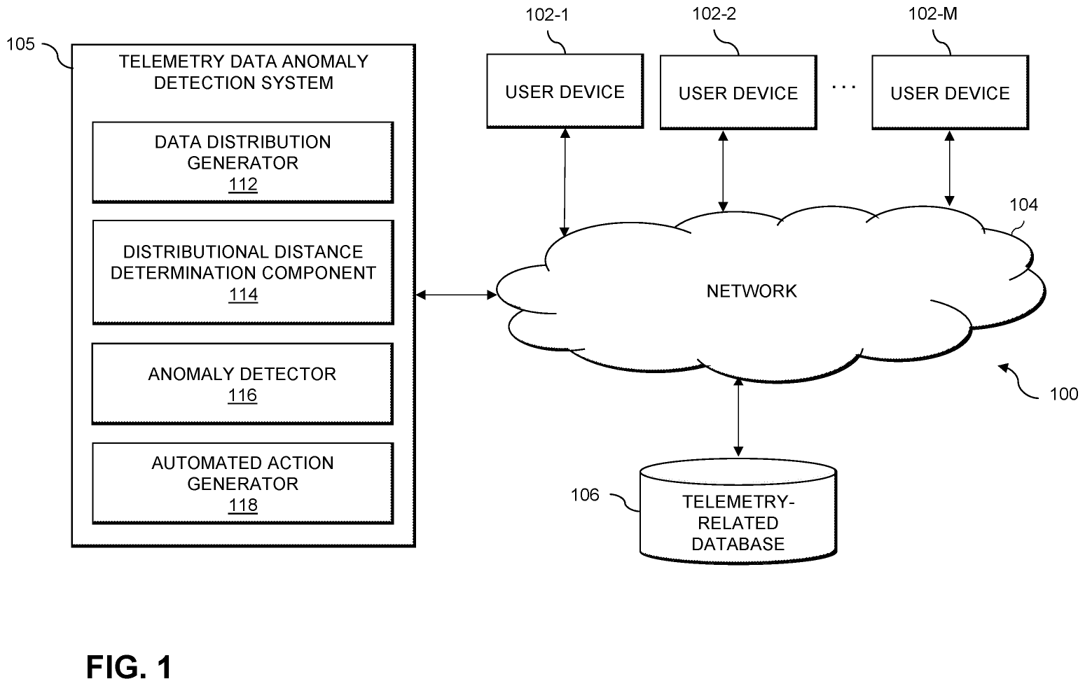

FIG. 1 shows a computer network (also referred to herein as an information processing system) 100 configured in accordance with an illustrative embodiment. In the example embodiment depicted in FIG. 1, the computer network 100 comprises a plurality of user devices 102-1, 102-2, . . . 102-M, collectively referred to herein as user devices 102. The user devices 102 are coupled to a network 104, wherein the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is telemetry data anomaly detection system 105.

The user devices 102 may comprise, for example, devices that generate telemetry data such as mobile telephones, laptop computers, tablet computers, desktop computers or other types of computing devices, as well as other devices that generate telemetry data such as vehicles, manufacturing equipment, building energy management systems, internet of things (IoT) devices, etc. Such devices are examples of what are more generally referred to herein as “processing devices.” Some of these processing devices are also generally referred to herein as “computers.” The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, telemetry data anomaly detection system 105 can have an associated telemetry-related database 106 configured to store telemetry data from various devices as well as data pertaining to telemetry data associated with and/or generated by various devices, which comprise, for example, historical telemetry data, current and/or ongoing telemetry data related to various metrics (e.g., power consumption (watts, amps, etc.), internal component temperature, airflow volume, airflow temperature, etc.), temporal data related to and/or associated with various portions of telemetry data, etc.

The telemetry-related database 106 in the present embodiment is implemented using one or more storage systems associated with telemetry data anomaly detection system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with telemetry data anomaly detection system 105 are one or more input-output devices, which illustratively comprise keyboards, displays or other types of input-output devices in any combination. Such input-output devices can be used, for example, to support one or more user interfaces to telemetry data anomaly detection system 105, as well as to support communication between telemetry data anomaly detection system 105 and other related systems and devices not explicitly shown.

Additionally, telemetry data anomaly detection system 105 in the FIG. 1 embodiment is assumed to be implemented using at least one processing device. Each such processing device generally comprises at least one processor and an associated memory, and implements one or more functional modules for controlling certain features of telemetry data anomaly detection system 105.

More particularly, telemetry data anomaly detection system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises, for example, random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture,” as used herein, should be understood to exclude transitory, propagating signals. These and other references to “disks” herein are intended to refer generally to storage devices, including solid-state drives (SSDs), and should therefore not be viewed as limited in any way to spinning magnetic media.

The network interface allows telemetry data anomaly detection system 105 to communicate over the network 104 with the user devices 102, and illustratively comprises one or more conventional transceivers.

The telemetry data anomaly detection system 105 further comprises data distribution generator 112, distributional distance determination component 114, anomaly detector 116, and automated action generator 118.

It is to be appreciated that this particular arrangement of elements 112, 114, 116 and 118 illustrated in the telemetry data anomaly detection system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for detecting anomalies in device telemetry data using distributional distance determinations involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, telemetry data anomaly detection system 105 and telemetry-related database 106 can be on and/or part of the same processing platform.

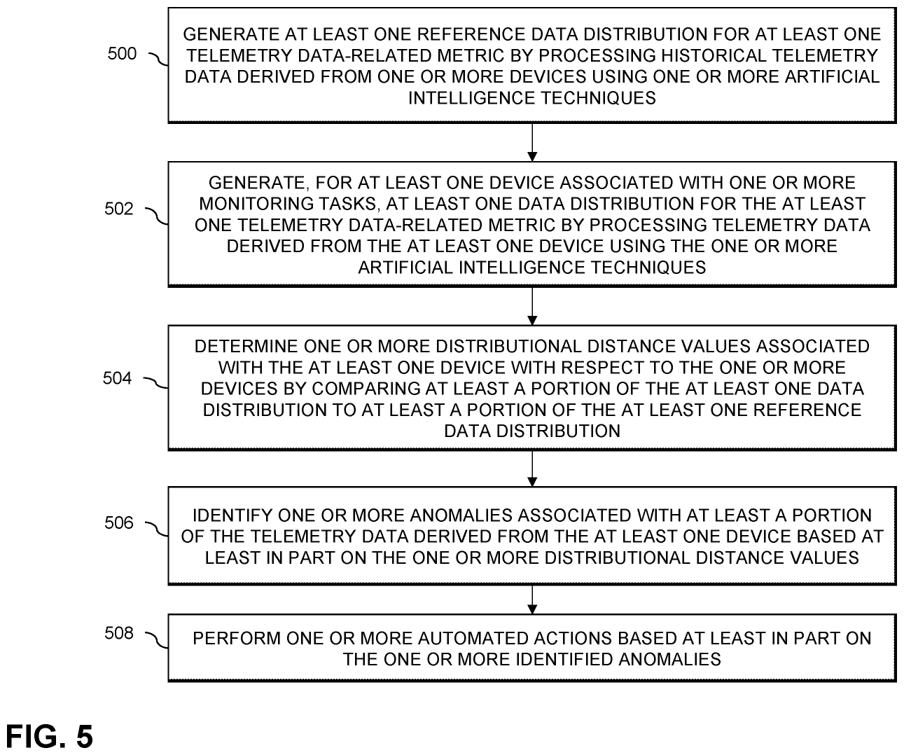

An exemplary process utilizing elements 112, 114, 116 and 118 of an example telemetry data anomaly detection system 105 in computer network 100 will be described in more detail with reference to the flow diagram of FIG. 5.

Accordingly, at least one embodiment includes using distributional distance to detect anomalies in machine generated telemetry data. Such an embodiment includes enabling and/or facilitating screening and/or analysis vast amounts of time series telemetry data to identify one or more devices and/or systems associated with one or more data anomalies. Additionally, such anomalies can be identified and/or classified as anomalies that warrant further investigation and/or that trigger one or more automated actions.

As further detailed herein, one or more embodiments include generating one or more outputs such as, for example, a prioritized list of devices ranked by the degree to which the corresponding telemetry data deviates from one or more expectations (e.g., one or more predetermined ranges of values). In such an embodiment, a prioritized list of ranked devices, after being generated, can be allocated to one or more work queues and/or related systems for further diagnosis and/or remedial action.

At least one embodiment includes defining at least one reference data distribution for each of one or more time series of interest (e.g., one or more time series associated with one or more particular metrics). As used herein, a reference distribution refers to a range of values in addition to a “shape,” for example, in the form of a histogram, showing the relative likelihood of observing values in different sub-ranges or actual value counts within different value sub-ranges. Also, as used herein, the shape indicates that the most likely value(s) and any emphasis and/or skewing of the values.

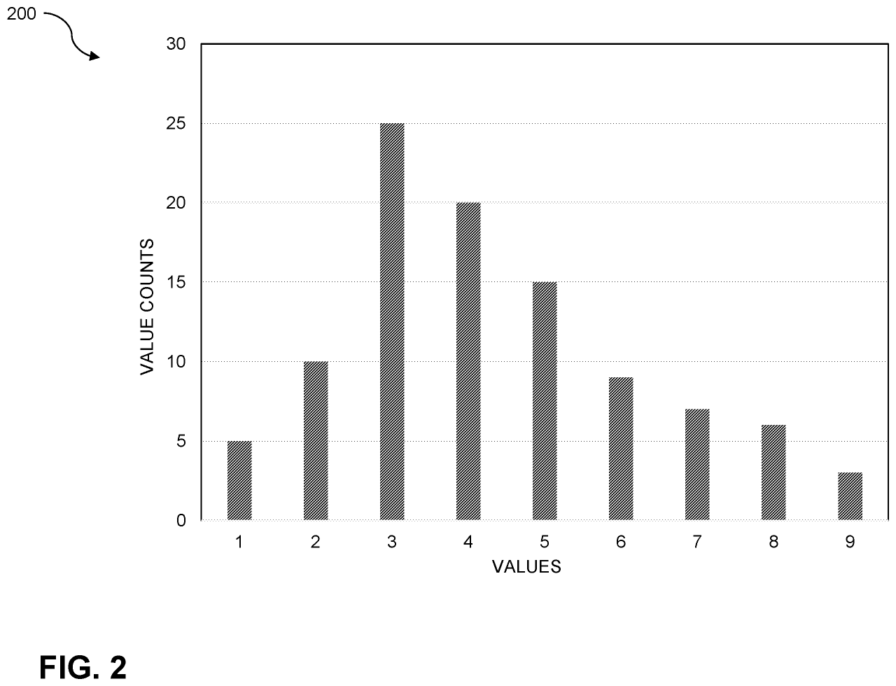

FIG. 2 shows an example reference distribution in an illustrative embodiment. By way of illustration, example reference distribution 200 includes a vertical axis which represents the value counts and/or value occurrence, and a horizontal axis which represents the range of possible and/or observed values. Specifically, in example reference distribution 200, the range of values is a range between one and nine, and the shape of the reference distribution indicates that the most likely value is three, and that the reference distribution is skewed to the right (i.e., to the right of the range of values).

In at least one embodiment, defining a reference data distribution can include deriving one or more values from one or more subject matter experts and/or determining one or more values by processing relevant historical data (e.g., if a sufficiently long period of stable operations has been retained for the device(s) and/or metric(s) in question).

In deriving a reference data distribution from historical data, at least one embodiment includes converting a continuous time series data stream into a discrete distribution by defining a set of bin boundaries that are mutually exclusive and cover the range of the input variable values. In such an embodiment, the result of such actions can include a distribution of observation counts for each bin range, the sum of which is equal to the total number of observations in the input dataset.

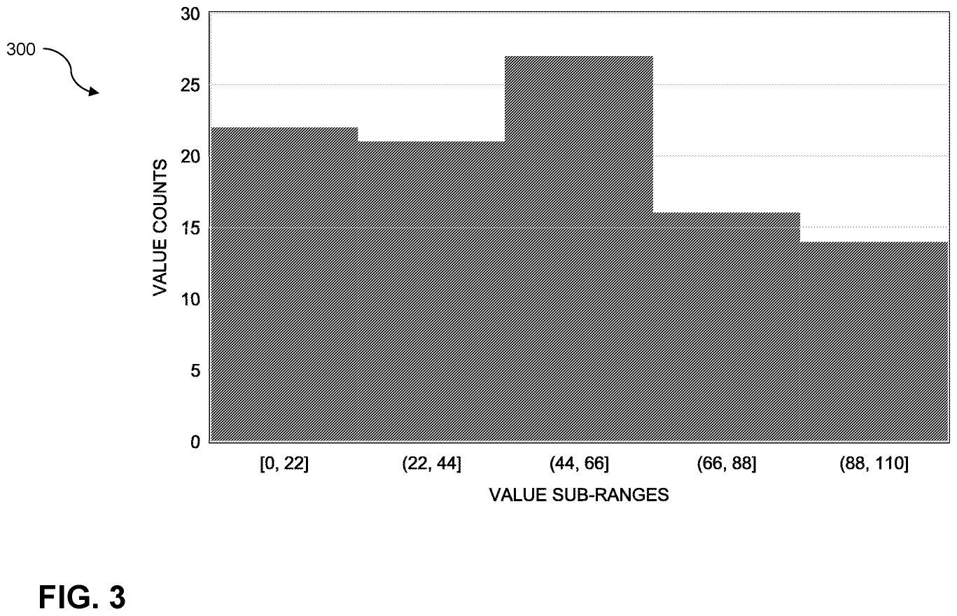

FIG. 3 shows an example graph of binning of continuous data in an illustrative embodiment. By way of illustration, FIG. 3 depicts an example graph 300 which illustrates how boundaries are used to convert a continuous-valued metric to a distribution using binning techniques. Specifically, example graph 300 shows example results of converting 100 values from a metric that can have any value within a range between 0 and 100 into a discrete distribution of five sub-ranges or bins. The bin boundaries are shown on the horizontal axis, with the first bin spanning all values between 0 and 22, the second bin including the count of values (represented via the horizontal axis) in the sub-range of 22 to 44, etc., with the last bin covering the sub-range from 88 to 100.

Additionally, such an embodiment includes retaining much of the information contained in the original dataset while greatly simplifying the computational requirements for comparing the similarity of the reference data distribution to many instances of the same metric coming from the monitored devices and/or systems in the environment during a screening stage.

The above-noted process for generating at least one reference data distribution from historical data can then be applied to the telemetry data of at least one system and/or device being monitored. In at least one embodiment, the range of values and the bin definitions are identical for both the generation of the reference data distribution and the monitored system and/or device. The two discrete distributions can then be compared for similarity and/or overlap based at least in part on the proportion of observations that are collected in each bin. For a system and/or device wherein there is a match of the exact proportions for every bin, one or more embodiments include concluding that there is complete overlap in the distributions.

Additionally or alternatively, at least one embodiment can include implementing and/or utilizing a comparison measure which includes concluding that there is zero distance between two distributions. Also, for systems and/or devices with no overlapping bin proportions, such an embodiment can include concluding that there is no similarity between the monitored system and/or device and the reference data distribution, and therefore, the distance therebetween is infinite. Between these two extreme results are comparisons in which there is some overlap. By way merely of example, these two extreme results can be assigned scores of zero and one, respectively, and results indicating some overlap can be assigned scores between zero and one, relative to the degree and/or extent of overlap, for purposes of comparing overlap and/or distance values.

Accordingly, one or more embodiments include comparing the overlap and/or distance for one or more metrics (e.g., every metric) that two or more systems and/or devices have in common. In such an embodiment, this computation produces data which can be used to determine and/or conclude which of the two or more systems and/or devices has or have the least similarity to a hypothetical reference system and/or device with respect to normal and/or expected telemetry data distributions.

In the case wherein there is not enough data to produce a suitable reference data distribution based on historical data, at least one embodiment can include deriving and/or obtaining expected proportions for each of one or more defined bins (e.g., deriving and/or obtaining such information from one or more subject matter experts and/or historical data) to form at least one reference data distribution for comparison to at least one corresponding metric from a system and/or device being monitored.

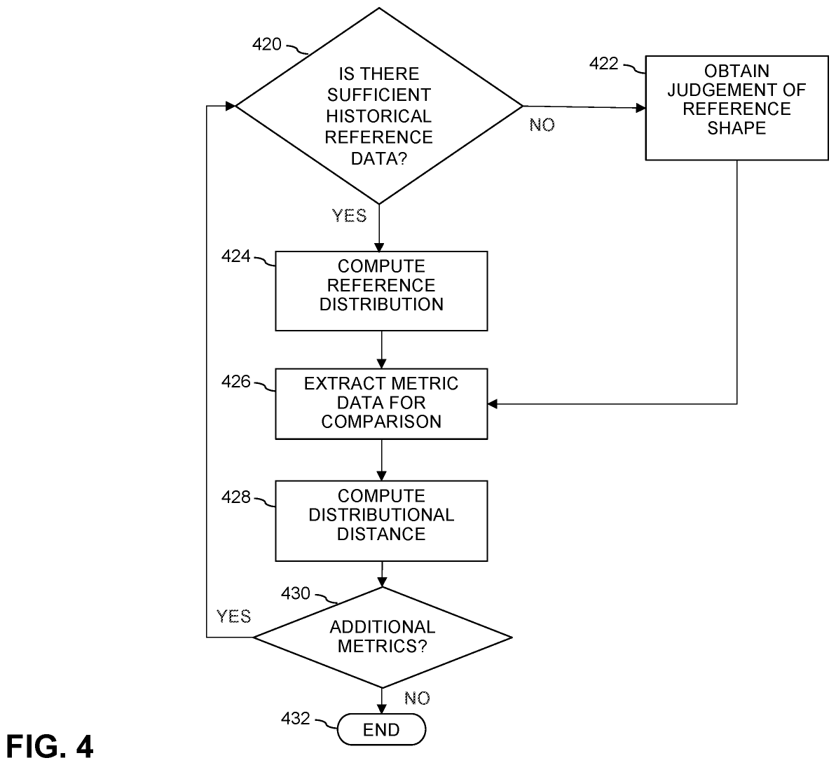

FIG. 4 shows an example workflow for computing distributional distance values in an illustrative embodiment. Step 420 includes determining if there is sufficient historical reference data. If no (i.e., there is insufficient historical reference data), then step 422 includes obtaining judgment (e.g., from one or more subject matter experts) of at least one reference shape and proceeding to step 426 in the FIG. 4 workflow. If yes (i.e., there is sufficient historical reference data), then step 424 includes computing at least one reference data distribution for at least one given metric using the historical reference data.

As also depicted in FIG. 4, subsequent to step 424, step 426 includes extracting metric data for comparison. For example, at least one embodiment can include obtaining telemetry data from one or more devices and extracting metric data pertaining to the at least one given metric associated with the at least one reference data distribution from the telemetry data. Such extracted metric data can then be compared to at least one corresponding reference data distribution. Further, step 428 includes computing, based at least in part on such comparison(s), at least one distributional distance value between the actual telemetry data associated with one or more devices and the at least one corresponding reference data distribution.

Additionally, step 430 includes determining if there are any additional metrics to be analyzed. If yes (i.e., there are one or more additional metrics to be analyzed), then the workflow returns to step 420. If no (i.e., there are no additional metrics to be analyzed), then the workflow ends at step 432.

FIG. 5 is a flow diagram of a process for detecting anomalies in device telemetry data using distributional distance determinations in an illustrative embodiment. It is to be understood that this particular process is only an example, and additional or alternative processes can be carried out in other embodiments.

In this embodiment, the process includes steps 500 through 508. These steps are assumed to be performed by telemetry data anomaly detection system 105 utilizing elements 112, 114, 116 and 118.

Step 500 includes generating at least one reference data distribution for at least one telemetry data-related metric by processing historical telemetry data derived from one or more devices using one or more artificial intelligence techniques. In one or more embodiments, the one or more artificial intelligence techniques can include one or more deep learning models trained and/or configured for processing time series data, such as, for example, one or more multilayer perceptrons (MLPs), one or more convolutional neural networks (CNNs), one or more long short-term memory networks (LSTMs), etc. Further, in at least one embodiment, generating the at least one reference data distribution includes processing historical telemetry data derived from one or more devices using one or more machine learning-based data discretization techniques. In such an embodiment, the one or more machine learning-based data discretization techniques include converting continuous data attribute values into a finite set of intervals with minimal loss of information, and such techniques can be used in conjunction with, for example, one or more deep learning models (e.g., one or more MLPs, one or more CNNs, one or more LSTMs, etc.).

Also, in at least one example embodiment, generating the at least one reference data distribution for the at least one telemetry data-related metric includes converting at least one continuous historical time series data stream derived from the one or more devices into at least one discrete data distribution by defining a set of two or more bin boundaries, wherein the two or more bin boundaries are mutually exclusive and cover at least one range of input variable values related to the at least one telemetry data-related metric. In such an embodiment, the two or more bin boundaries cover at least one range of input variable values equal to a total number of observations in the at least one continuous historical time series data stream. Additionally, in such an embodiment, generating the at least one reference data distribution for the at least one telemetry data-related metric can include incorporating one or more user-provided expectations for each of the two or more bins boundaries.

Step 502 includes generating, for at least one device associated with one or more monitoring tasks, at least one data distribution for the at least one telemetry data-related metric by processing telemetry data derived from the at least one device using the one or more artificial intelligence techniques. In one or more embodiments, generating the at least one data distribution for the at least one device includes converting at least one continuous time series data stream derived from the at least one device into at least one discrete data distribution by defining a set of two or more bin boundaries, wherein the two or more bin boundaries are mutually exclusive and cover at least one range of input variable values related to the at least one telemetry data-related metric. In such an embodiment, generating the at least one reference data distribution can include converting at least one continuous historical time series data stream derived from the one or more devices into at least one discrete data distribution by defining a set of two or more bin boundaries which are identical to the set of two or more bin boundaries defined in connection with generating the at least one data distribution for the at least one device.

Step 504 includes determining one or more distributional distance values associated with the at least one device with respect to the one or more devices by comparing at least a portion of the at least one data distribution to at least a portion of the at least one reference data distribution. In one or more embodiments, such distributional distance value determinations can be carried out using, for example, at least a portion of the one or more artificial intelligence techniques.

Step 506 includes identifying one or more anomalies associated with at least a portion of the telemetry data derived from the at least one device based at least in part on the one or more distributional distance values. In at least one embodiment, identifying one or more anomalies includes generating at least one list of instances of deviation of the at least one data distribution from the at least one reference data distribution ranked in accordance with an amount by which a corresponding portion of the telemetry data derived from the at least one device deviates from one or more expectations associated with the historical telemetry data derived from the one or more devices.

Step 508 includes performing one or more automated actions based at least in part on the one or more identified anomalies. In one or more embodiments, performing one or more automated actions includes initiating, in connection with one or more systems, one or more automated actions responsive to at least one of the one or more identified anomalies. Also, performing one or more automated actions can include classifying the one or more identified anomalies using one or more classification techniques. Additionally or alternatively, performing one or more automated actions can include automatically training the one or more artificial intelligence techniques using feedback related to one or more identified anomalies.

Accordingly, the particular processing operations and other functionality described in conjunction with the flow diagram of FIG. 5 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to detect anomalies in device telemetry data using distributional distance determinations. These and other embodiments can effectively overcome problems associated with the error-prone limited data analyses of conventional approaches.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

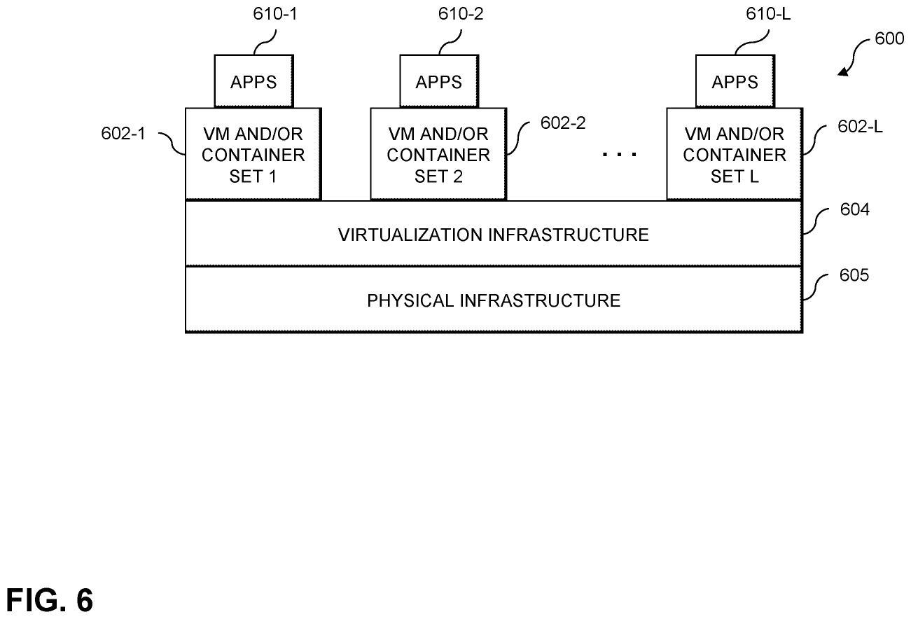

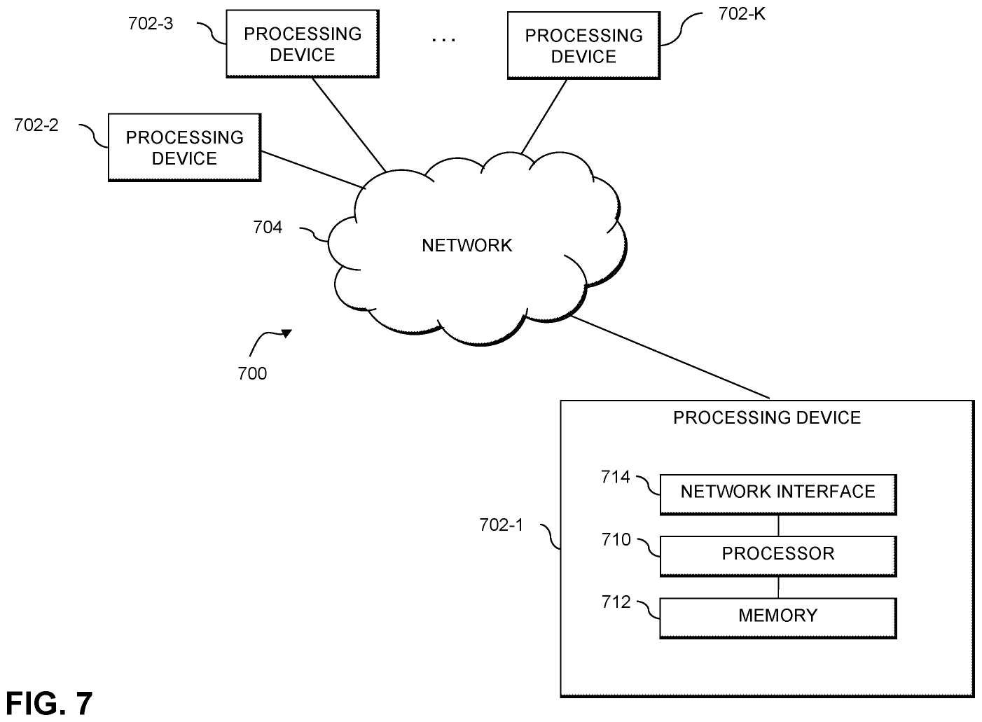

Illustrative embodiments of processing platforms will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, wherein the hypervisor platform has an associated virtual infrastructure management system. The underlying physical machines comprise one or more information processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, a CPU, a GPU, a TPU, a microcontroller, an ASIC, a FPGA or other type of processing circuitry, as well as portions or combinations of such circuitry elements.

The memory 712 comprises random access memory (RAM), read-only memory (ROM) or other types of memory, in any combination. The memory 712 and other memories disclosed herein should be viewed as illustrative examples of what are more generally referred to as “processor-readable storage media” storing executable program code of one or more software programs. Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in one or more illustrative embodiments include all-flash and hybrid flash storage arrays, scale-out all-flash storage arrays, scale-out NAS clusters, or other types of storage arrays. Combinations of multiple ones of these and other storage products can also be used in implementing a given storage system in one or more illustrative embodiments.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
generating at least one reference data distribution for at least one telemetry data-related metric by processing historical telemetry data derived from one or more devices using one or more artificial intelligence techniques;
generating, for at least one device associated with one or more monitoring tasks, at least one data distribution for the at least one telemetry data-related metric by processing telemetry data derived from the at least one device using the one or more artificial intelligence techniques;
determining one or more distributional distance values associated with the at least one device with respect to the one or more devices by comparing at least a portion of the at least one data distribution to at least a portion of the at least one reference data distribution;
identifying one or more anomalies associated with at least a portion of the telemetry data derived from the at least one device based at least in part on the one or more distributional distance values; and
performing one or more automated actions based at least in part on the one or more identified anomalies;
wherein the method is performed by at least one processing device comprising a processor coupled to a memory.

2. The computer-implemented method of claim 1, wherein generating the at least one reference data distribution for the at least one telemetry data-related metric comprises converting at least one continuous historical time series data stream derived from the one or more devices into at least one discrete data distribution by defining a set of two or more bin boundaries, wherein the two or more bin boundaries are mutually exclusive and cover at least one range of input variable values related to the at least one telemetry data-related metric.

3. The computer-implemented method of claim 2, wherein the two or more bin boundaries cover at least one range of input variable values equal to a total number of observations in the at least one continuous historical time series data stream.

4. The computer-implemented method of claim 2, wherein generating the at least one reference data distribution for the at least one telemetry data-related metric comprises incorporating one or more user-provided expectations for each of the two or more bins boundaries.

5. The computer-implemented method of claim 1, wherein generating the at least one data distribution for the at least one device comprises converting at least one continuous time series data stream derived from the at least one device into at least one discrete data distribution by defining a set of two or more bin boundaries, wherein the two or more bin boundaries are mutually exclusive and cover at least one range of input variable values related to the at least one telemetry data-related metric.

6. The computer-implemented method of claim 5, wherein generating the at least one reference data distribution comprises converting at least one continuous historical time series data stream derived from the one or more devices into at least one discrete data distribution by defining a set of two or more bin boundaries which are identical to the set of two or more bin boundaries defined in connection with generating the at least one data distribution for the at least one device.

7. The computer-implemented method of claim 1, wherein identifying one or more anomalies comprises generating at least one list of instances of deviation of the at least one data distribution from the at least one reference data distribution ranked in accordance with an amount by which a corresponding portion of the telemetry data derived from the at least one device deviates from one or more expectations associated with the historical telemetry data derived from the one or more devices.

8. The computer-implemented method of claim 1, wherein generating the at least one reference data distribution comprises processing historical telemetry data derived from one or more devices using one or more machine learning-based data discretization techniques.

9. The computer-implemented method of claim 1, wherein performing one or more automated actions comprises initiating, in connection with one or more systems, one or more automated actions responsive to at least one of the one or more identified anomalies.

10. The computer-implemented method of claim 1, wherein performing one or more automated actions comprises classifying the one or more identified anomalies using one or more classification techniques.

11. The computer-implemented method of claim 1, wherein performing one or more automated actions comprises automatically training the one or more artificial intelligence techniques using feedback related to one or more identified anomalies.

12. A non-transitory processor-readable storage medium having stored therein program code of one or more software programs, wherein the program code when executed by at least one processing device causes the at least one processing device:
to generate at least one reference data distribution for at least one telemetry data-related metric by processing historical telemetry data derived from one or more devices using one or more artificial intelligence techniques;
to generate, for at least one device associated with one or more monitoring tasks, at least one data distribution for the at least one telemetry data-related metric by processing telemetry data derived from the at least one device using the one or more artificial intelligence techniques;
to determine one or more distributional distance values associated with the at least one device with respect to the one or more devices by comparing at least a portion of the at least one data distribution to at least a portion of the at least one reference data distribution;
to identify one or more anomalies associated with at least a portion of the telemetry data derived from the at least one device based at least in part on the one or more distributional distance values; and
to perform one or more automated actions based at least in part on the one or more identified anomalies.

13. The non-transitory processor-readable storage medium of claim 12, wherein
generating the at least one reference data distribution for the at least one telemetry data-related metric comprises converting at least one continuous historical time series data stream derived from the one or more devices into at least one discrete data distribution by defining a set of two or more bin boundaries, wherein the two or more bin boundaries are mutually exclusive and cover at least one range of input variable values related to the at least one telemetry data-related metric.

14. The non-transitory processor-readable storage medium of claim 12, wherein
generating the at least one data distribution for the at least one device comprises converting at least one continuous time series data stream derived from the at least one device into at least one discrete data distribution by defining a set of two or more bin boundaries, wherein the two or more bin boundaries are mutually exclusive and cover at least one range of input variable values related to the at least one telemetry data-related metric.

15. The non-transitory processor-readable storage medium of claim 14, wherein
generating the at least one reference data distribution comprises converting at least one continuous historical time series data stream derived from the one or more devices into at least one discrete data distribution by defining a set of two or more bin boundaries which are identical to the set of two or more bin boundaries defined in connection with generating the at least one data distribution for the at least one device.

16. An apparatus comprising:
at least one processing device comprising a processor coupled to a memory;
the at least one processing device being configured:
to generate at least one reference data distribution for at least one telemetry data-related metric by processing historical telemetry data derived from one or more devices using one or more artificial intelligence techniques;
to generate, for at least one device associated with one or more monitoring tasks, at least one data distribution for the at least one telemetry data-related metric by processing telemetry data derived from the at least one device using the one or more artificial intelligence techniques;
to determine one or more distributional distance values associated with the at least one device with respect to the one or more devices by comparing at least a portion of the at least one data distribution to at least a portion of the at least one reference data distribution;
to identify one or more anomalies associated with at least a portion of the telemetry data derived from the at least one device based at least in part on the one or more distributional distance values; and
to perform one or more automated actions based at least in part on the one or more identified anomalies.

17. The apparatus of claim 16, wherein generating the at least one reference data distribution for the at least one telemetry data-related metric comprises converting at least one continuous historical time series data stream derived from the one or more devices into at least one discrete data distribution by defining a set of two or more bin boundaries, wherein the two or more bin boundaries are mutually exclusive and cover at least one range of input variable values related to the at least one telemetry data-related metric.

18. The apparatus of claim 16, wherein generating the at least one data distribution for the at least one device comprises converting at least one continuous time series data stream derived from the at least one device into at least one discrete data distribution by defining a set of two or more bin boundaries, wherein the two or more bin boundaries are mutually exclusive and cover at least one range of input variable values related to the at least one telemetry data-related metric.

19. The apparatus of claim 18, wherein generating the at least one reference data distribution comprises converting at least one continuous historical time series data stream derived from the one or more devices into at least one discrete data distribution by defining a set of two or more bin boundaries which are identical to the set of two or more bin boundaries defined in connection with generating the at least one data distribution for the at least one device.

20. The apparatus of claim 16, wherein performing one or more automated actions comprises initiating, in connection with one or more systems, one or more automated actions responsive to at least one of the one or more identified anomalies.
